(19) United States
(12) Patent Application Publication
(10) Pub. No.: US 2015/0185675 A1
(43) Pub. Date: Jul. 2, 2015

(54) IMAGE FORMING APPARATUS AND ADJUSTMENT METHOD THEREFOR

(71) Applicant: CANON KABUSHIKI KAISHA, TOKYO (JP)

(72) Inventor: Hirokazu TAMURA, Chofu-shi (JP)

(21) Appl. No.: 14/567,164

(22) Filed: Dec. 11, 2014

(30) Foreign Application Priority Data
Dec. 27, 2013 (JP) 2013-273170

(51) Int. Cl. G03G 15/00

(52) U.S. Cl. CPC G03G 15/556

(57) ABSTRACT

An amount of used toner is estimated based on the density independent of a recording medium, which is obtained from an intermediate transfer member, and on the density dependent on a recording medium, which is obtained from a recording medium. Patches are formed on a target print medium both under a process condition using the estimated toner amount, and under process conditions in which the toner amount changes on the basis of the estimated toner amount. Densities of the patches are measured, a process condition yielding a target density is identified, an image is formed under the identified condition, an amount of toner consumed to yield the target density under the identified condition is used as the largest toner amount for a single color component, and a toner mounting amount serving as an upper limit is converted into a density scale.

### BACKGROUND OF THE INVENTION

1. Field of the Invention

The present invention relates to an image forming apparatus that obtains an output image by applying toner to an image carrier, such as a photosensitive member and an intermediate transfer member, and transferring the toner to a surface of a sheet, and that adjusts an optimal value while changing density control factors that influence the image density of a toner image. The present invention also relates to an adjustment method for that image forming apparatus.

2. Description of the Related Art

An electrophotographic method is known as an image recording method used in an image forming apparatus, such as a printer and a copier. The electrophotographic method forms a latent image on a photosensitive drum mainly using a laser beam, and develops the latent image with a charged recording agent (hereinafter referred to as toner). The image developed with the toner is transferred and fixed; as a result, the image is recorded. A full-color image can be formed by using four colors of toner, that is to say, cyan, magenta yellow, and black (hereinafter, these colors are collectively referred to as CMYK).

This color image forming apparatus executes several types of calibration processing for improving the stability of the image density.

Specific methods of calibration processing will now be described. First of all, there is a method in which a particular pattern, such as a tone pattern, is printed on a paper or other recording mediums, and the tone pattern is read by an image reading apparatus, such as a reader scanner. According to this method, calibration is performed by feeding back information obtained as a result of reading to image forming conditions, such as γ correction for correcting the tone properties, of a printer and other image forming apparatuses.

There is another method in which a plurality of patch patterns of a predetermined density level are formed as toner images on an intermediate transfer member in an apparatus, and the densities of these patch patterns are measured by a sensor provided in the apparatus. In this case, calibration is performed by calculating density characteristics corresponding to an input level based on the result of measurement, generating a density correction table such that an input density level of print data has a predetermined standard density value, and feeding back the density correction table to image forming conditions. Through the foregoing processes, the stability of the density of an output image is maintained.

However, the quality of an output image obtained from the foregoing image forming apparatuses significantly depends on convexities and concavities of fibers on a surface of a recording medium, and on the surface smoothness attributed to production processes (hereinafter, they are referred to as surface properties). That is to say, even if printing is conducted under the same condition, the density of an output image differs between a case in which a recording medium with rough surface properties is used and a case in which a recording medium with smooth surface properties is used. Specifically, in the case of a recording medium with rough surface properties, toner looks light because it enters gaps between fibers of the recording medium. As a result, not only does an image look low in density, but also a thin line that has been drawn may look discontinuous; that is to say, the output image is degraded. In view of these problems, a technique to control an amount of used toner in accordance with the surface properties of a recording medium is disclosed (Japanese Patent Laid-Open No. 2000-89532).

Unfortunately, with this technique to control a toner amount in accordance with a recording medium, it is necessary that the surface properties of the recording medium be already known. However, it is difficult to deal with every single one of a wide variety of recording mediums that could possibly be used by a user.

Also, in the case of control in which a pattern printed on a recording medium is read by an image reading apparatus, such as a scanner, so as to reproduce an image of an appropriate density suited for the recording medium, an amount of toner used to reproduce an image of a desired density cannot be known if the surface properties of the recording medium are unknown. Therefore, especially on a recording medium with rough surface properties, a large amount of toner could possibly be used to reproduce an image of a desired density. This may result in poor fixing due to failure to apply toner by pressure, as well as splattering of toner, at the time of image fixing.

As described above, it has been difficult to perform control for restricting a total toner amount so as not to cause poor fixing at the time of image fixing while reproducing an image of a desired density by estimating an amount of used toner with the properties of a recording medium remaining unknown.

### SUMMARY OF THE INVENTION

In order to solve the above-described problems, an image forming apparatus of the present invention is configured as follows.

An image forming apparatus, in which an upper limit value of an amount of recording agent per unit area used in image formation has been preset, includes: calculation means for forming a patch on a medium that is not used as a print medium under a plurality of conditions that yield different densities, and calculates amounts of recording agent used for the patches; forming means for, based on the calculated amounts of used recording agent, forming on a target print medium a plurality of patches using different amounts of recording agent under a plurality of different conditions; means for measuring densities of the plurality of patches formed on the target print medium, and identifies a patch of a target density; means for storing, among the plurality of different conditions, a condition corresponding to the patch of the target density as a condition for image formation; and means for converting the upper limit value into a total density value based on an amount of used recording agent corresponding to the patch of the target density.

The present invention enables control for restricting a total toner amount so as not to cause poor fixing at the time of image fixing while reproducing target solid-color tone properties by estimating an amount of toner used to reproduce a desired density, even if the surface properties of a recording medium are unknown.

Further features of the present invention will become apparent from the following description of exemplary embodiments with reference to the attached drawings.

### BRIEF DESCRIPTION OF THE DRAWINGS

FIG. 1 is a block diagram showing a general configuration of an image forming apparatus according to an embodiment of the present invention.

FIG. 2 is a detailed configuration diagram of a print engine in the image forming apparatus.

FIG. 3 is a flow diagram of printed image processing according to a first embodiment.

FIG. 4 is a detailed explanatory flow diagram of control for a total toner amount according to the first embodiment.

FIG. 5 shows a relationship between input and an output density and γ correction according to the first embodiment.

FIG. 6 is a flow diagram of calibration processing according to the first embodiment.

FIG. 7 depicts an image of patches on an intermediate transfer member according to the first embodiment.

FIG. 8 is a flow diagram of calibration processing according to a second embodiment.

FIG. 9 depicts an image of patches on a recording medium according to the second embodiment.

FIGS. 10A and 10B show a relationship between input and an output density and γ correction according to the second embodiment.

FIG. 11 is a flow diagram of printed image processing according to a third embodiment.

### DESCRIPTION OF THE EMBODIMENTS

The following describes the embodiments of the present invention with reference to the attached drawings.

### First Embodiment

### Configuration of Image Forming Apparatus

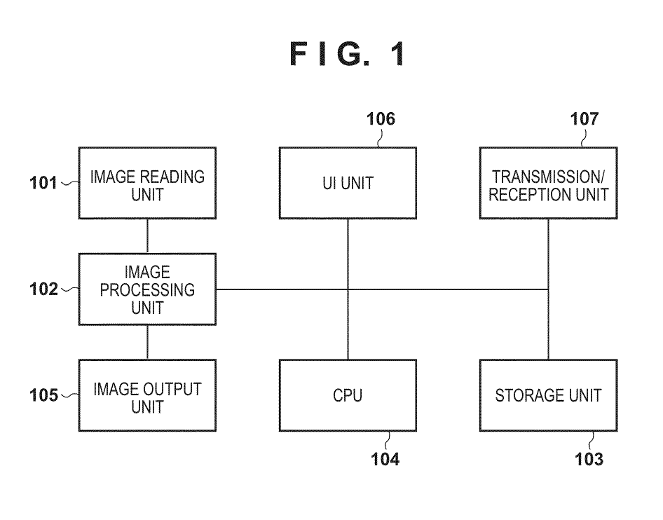

FIG. 1 is a block diagram showing a configuration of an image forming apparatus according to a working example.

As shown in FIG. 1, the image forming apparatus includes an image reading unit 101, an image processing unit 102, a storage unit 103, a CPU 104, an image output unit 105, a UI unit 106, and a reception unit 107. The image forming apparatus is connectable to, for example, a server that manages image data and a personal computer (PC) that issues an instruction for conducting printing via a network and the like.

The image reading unit 101 is a reader device that reads a sheet of document placed on a platen by scanning the same, and outputs image data. It has a three-line sensor for red, green and blue, and can obtain 8-bit data as image data for each of R, G and B.

The image processing unit 102 converts print information including image data input from the outside via the image reading unit 101, the transmission/reception unit 107, and the like into intermediate information (hereinafter referred to as an “object”), and stores the intermediate information into an object buffer of the storage unit 103. It also generates bitmap data based on the buffered object, and stores the bitmap data into a buffer of the storage unit 103. At this time, a process for color conversion into CMYK, a γ correction process, and the like are executed. The details thereof will be described later.

The storage unit 103 is constituted by a ROM, a RAM, a hard disk (HD), and the like. The ROM stores various types of control programs, a tone control program, and an image processing program executed by the CPU 104. The RAM is used as a working area and a reference area into which the CPU 104 stores data and various types of information. The RAM and HD are used in, for example, a storage process involving the aforementioned object buffer. They also store processing parameters (e.g., a lookup table) necessary for image processing. Image data, page sorting, and a document composed of a plurality of sorted pages are accumulated in these RAM and HD so as to print out a plurality of copies.

The image output unit 105 is a printer engine that forms a color image on a recording medium, such as a recording sheet, and outputs the recording medium. A detailed configuration thereof will be described later. The UI unit 106 performs an operation for issuing, to the apparatus, instructions related to a type, level adjustment, and the like of image processing in the image processing unit. For example, it sets an amount of adjustment for the aforementioned image adjustment processing. The transmission/reception unit 107 receives image data for printing from the outside, and stores the image data into the storage unit 103 or outputs the image data to the output unit 105. It also transmits/outputs image data accumulated in the storage unit 103 to the outside of the apparatus.

<Configuration of Printer Engine>

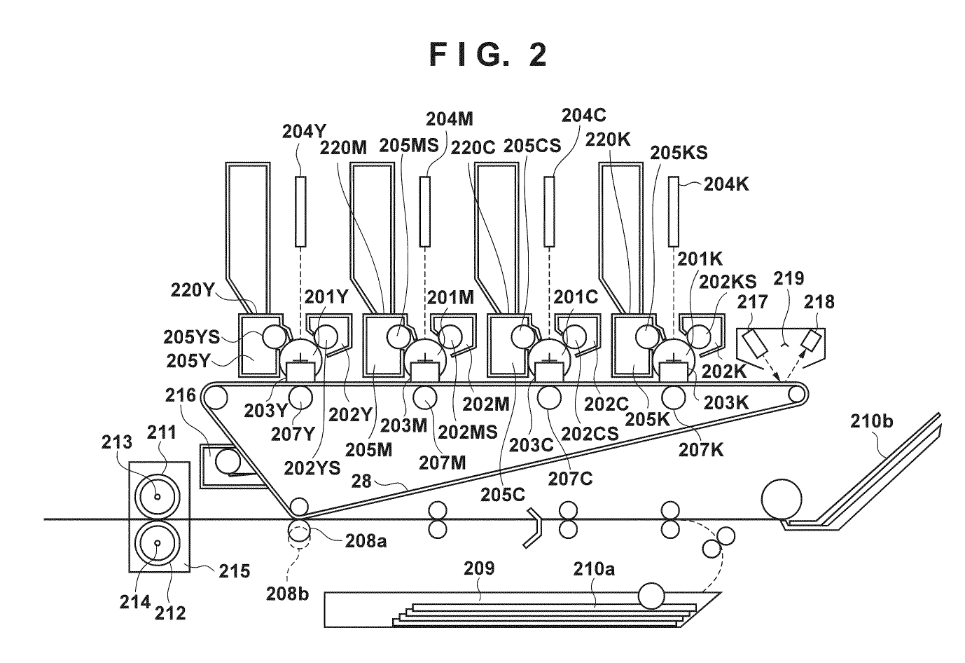

FIG. 2 provides a more detailed illustration of the printer engine represented by the image output unit 105, and shows a detailed configuration of the printer engine, which serves as a color image processing apparatus of an electrophotographic method according to the present embodiment. In this configuration, color-based components are arranged in order of yellow, magenta, cyan and black, and therefore the expression YMCK is used in the description of this figure.

A charging unit includes four injection chargers 202Y, 202M, 202C and 202K that charge photosensitive members 201Y, 201M, 201C and 201K corresponding to the colors Y, M, C and K, respectively. These injection chargers include sleeves 202YS, 202MS, 202CS and 202KS, respectively.

The photosensitive members 201Y, 201M, 201C and 201K rotate due to transmission of driving forces of driving motors 203Y, 203M, 203C and 203K thereto, and the driving motors cause the photosensitive members 201Y, 201M, 201C and 201K to rotate in a counterclockwise direction in accordance with an image forming operation.

An exposure unit irradiates the photosensitive members 201Y, 201M, 201C and 201K with exposure light beams from scanner units 204Y, 204M, 204C and 204K. The exposure unit is configured to form an electrostatic latent image by selectively exposing the surfaces of the photosensitive members 201Y, 201M, 201C and 201K to light. Here, the scanner units 204Y, 204M, 204C and 204K are capable of emitting multiple laser beams as multiple exposure light beams. By adjusting light amounts of these laser beams and exposure potentials of the photosensitive members, a potential difference of the electrostatic latent image increases, thereby enabling the adjustment of the density of a toner image in a subsequent developing unit. These setting conditions including the light amounts of laser beams and the potentials of the photosensitive members are collectively referred to as a process condition, and a detailed flow for determining a process condition that yields a target output density will be described later.

The developing unit includes four developers 205Y, 205M, 205C and 205K that perform development for the colors Y, M, C and K, respectively, to visualize the aforementioned electrostatic latent image, and these developers include sleeves 205YS, 205MS, 205CS and 205KS, respectively. Each of the developers 205Y, 205M, 205C and 205K is attachable/detachable.

A transfer unit causes an intermediate transfer member 206 to rotate in a clockwise direction so as to transfer solid-color toner images from the photosensitive members 201Y, 201M, 201C and 201K to the intermediate transfer member 206. Then, the transfer unit transfers the solid-color toner images in harmony with rotations of the photosensitive members 201Y, 201M, 201C and 201K and primary transfer rollers 207Y, 207M, 207C and 207K that are located to oppose the photosensitive members. By applying an appropriate bias voltage to the primary transfer rollers 207 and differentiating the rotation speed of the photosensitive members 201Y, 201M, 201C and 201K from the rotation speed of the intermediate transfer member 206, the solid-color toner images are efficiently transferred onto the intermediate transfer member 206. This is called primary transfer.

The transfer unit also layers the solid-color toner images on the intermediate transfer member 206 on a station-by-station basis, and conveys the layered images, that is to say, a multicolor toner image to a secondary transfer roller 208 in harmony with the rotation of the intermediate transfer member 206.

The transfer unit further holds and conveys a recording medium 209 from a feed tray 210a or a feed tray 210b to the secondary transfer roller 208, and transfers the multicolor toner image formed on the intermediate transfer member 206 to the recording medium 209. The toner image is electrostatically transferred by applying an appropriate bias voltage to this secondary transfer roller 208. This is called secondary transfer. The secondary transfer roller 208 is in contact with the recording medium 209 at a position 208a while transferring the multicolor toner image onto the recording medium 209, and is separated therefrom at a position 208b after print processing.

In order to fix the multicolor toner image transferred to the recording medium 209 on the recording medium 209 by fusing, a fixing apparatus 215 includes a fixing roller 211 for heating the recording medium 209 and a pressurizing roller 212 for causing the recording medium 209 to come in contact with the fixing roller 211 by pressure. The fixing roller 211 and the pressurizing roller 212 are formed into a hollow shape, and have heaters 213 and 214 built therein, respectively. The fixing apparatus 215 conveys the recording medium 209 holding the multicolor toner image with the fixing roller 211 and the pressurizing roller 212, and fixes the toner, that is to say, the recording agent to the recording medium 209 by applying heat and pressure.

After the toner has been fixed, the recording medium 209 is discharged to a discharge tray (not shown) by a discharge roller (not shown), and the image forming operation is completed. A cleaning unit 216 cleans toner remaining on the intermediate transfer member 206, and waste toner that remains after transferring the multicolor or four-color toner image formed on the intermediate transfer member 206 to the recording medium 209 is collected in a waste toner bottle (not shown). Toner used for a patch pattern that is formed in a non-image forming region at the time of density correction is also processed by this cleaning unit 216 as waste toner.

Also, an amount of toner used to form images is estimated for each of Y, M, C and K on an image-by-image basis, and supply mechanisms 220Y, 220M, 220C and 220K supply toner to the developers 205Y, 205M, 205C and 205K in accordance with used toner. This amount of toner (that is to say, recording agent) used on an image-by-image basis differs depending on the substance of an output image; therefore, each time an image is output, a supply operation is performed in response to a notification of a value thereof from the CPU 104.

A patch pattern generated on the intermediate transfer member 206 for density correction is delivered to the CPU 104 for use in control, after a toner image on the intermediate transfer member is converted into an electrical signal by a photosensor 219 constituted by an LED 217 and a photodiode 218 and then processed through A/D conversion. The details of density correction using a sensor value thereof will also be described later.

<Image Output Processing>

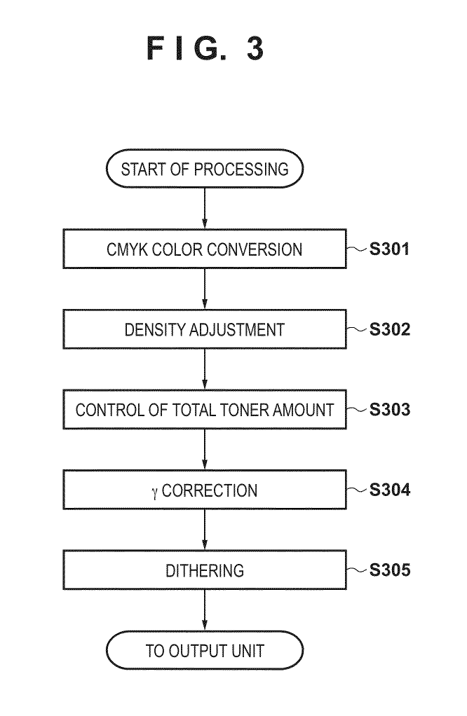

With reference to FIG. 3, the following describes the flow of printed image output processing of the image processing unit 102 for obtaining a printed image. An image input for this print processing is an image from the image reading unit 101 in the case of printing deriving from a copy instruction from a user, and is an RGB image received by the transmission/reception unit 107 in the case of printing from the outside.

In step S301, image data input from the outside via the image reading unit 101, the transmission/reception unit 107, and the like is converted into CMYK image data of a CMYK color space suited for a printer device. As an input image is normally an RGB image, nonlinear conversion is realized by using a known three-dimensional lookup table in conversion into the CMYK color space. It is assumed that this table is stored in the storage unit 103, and the output has an 8-bit value from 0 to 255 on a pixel-by-pixel basis. With regard to a color component of any color, a value of 0 indicates no use of toner (white), a larger value indicates higher density, and a value of 255 indicates a target highest density.

In the subsequent step S302, the image processing unit 102 makes density adjustment to CMYK signals obtained in the earlier process for each color. As values of the signals correspond to the densities of respective colors, the densities are increased by providing higher values of signals and reduced by providing lower values of signals in this adjustment. The easiest example of the present process may be the addition of an offset (ofst) to a product of input and gain; for instance, output C′ corresponding to input C is expressed as C′=C×gain+ofst. In order to increase the densities, gain is set to a value larger than one, and ofst is set to a value larger than zero. Conversely, in order to reduce the densities, gain is set to a positive value smaller than one, and ofst is set to a value smaller than zero. In a case where no adjustment is to be made, gain is set to one, and ofst is set to zero. As stated earlier, a value of a color component is 8-bit data that takes a value between 0 and 255, and therefore a value below 0 is clipped to 0 and a value above 255 is clipped to 255. An instruction for this adjustment is issued by the UI unit 106 so as to enable user's preferences to be reflected.

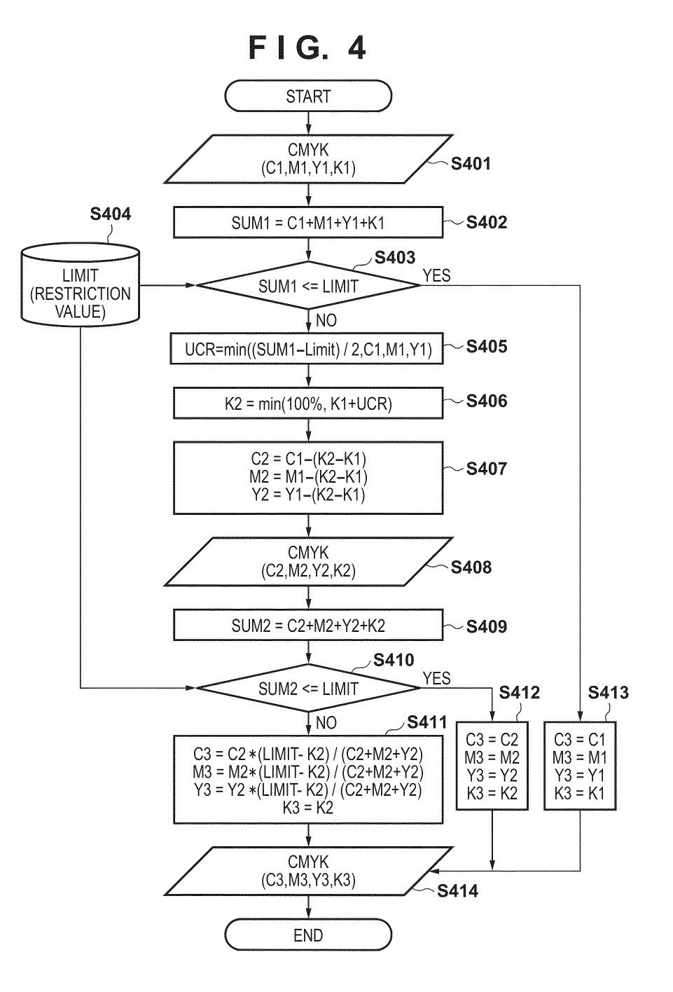

In the subsequent step S303, the image processing unit 102 applies a process for restricting a total toner amount to the CMYK signals processed in the earlier process. If a total amount of toner of four colors used in a certain unit area exceeds a prescribed amount, poor fixing may occur due to shortage in a heat capacity necessary for fixing; in view of this, the present process restricts the total amount to an amount with which fixing can be performed. The details of the present process will be described with reference to FIG. 4.

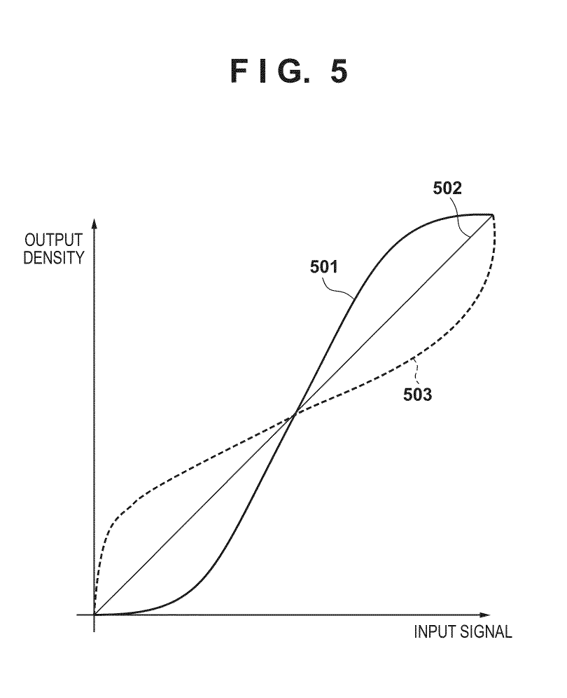

In the subsequent step S304, the image processing unit 102 applies a γ correction process suited for the density tone characteristics of the output unit 105 to the CMYK signals (color component values) obtained in the earlier process. FIG. 5 shows an example of the typical density tone characteristics. As a result of a dithering process that normally follows, the output unit 105 does not show linear reaction with respect to the density. A characteristics curve 501 of FIG. 5 represents an example of the tone properties (density) of output corresponding to input. For example, in a highlight portion (a portion with a low output density), it is difficult to raise the density with respect to input; conversely, in a dark portion (a portion with a high output density), tone is flattened (that is to say, saturated) with respect to input. This is corrected by applying a correction table, such as a correction curve 503 that is symmetric with respect to target tone properties 502, so as to yield an output density linearly with respect to an input signal. As a relationship between input and output before correction often has nonlinear characteristics, the present process is realized by conversion using one-dimensional lookup tables in which input and output are in a one-to-one relationship. Considering that different dithering matrices are used for different colors C, M, Y and K, the present process is executed using different lookup tables for different colors C, M, Y and K. It should be noted that the tables used in the present process are also stored in the storage unit 103, and 8-bit data is output for a single pixel.

In the subsequent step S305, the image processing unit 102 binarizes an image by applying a dithering process to the 8-bit CMYK signals obtained in the earlier process. The present process is also realized by performing pattern conversion using a dithering method that makes use of known dithering matrices. In the dithering method, moiré of a mixture of four colors is reduced by using patterns that have different screen angles for different colors; therefore, normally, different dithering matrices are used for different colors. This is a major reason why the tone properties differ with each color, and it is necessary to use different tables for different colors in the aforementioned γ correction process. It should be noted that the dithering matrices used in the present process are also stored in the storage unit 103, and 1-bit data is output for a single pixel in the present process.

A favorable image quality can be achieved by providing the printer engine of the output unit 105 with 1-bit pattern data of each of the colors C, M, Y and K obtained in the above-described manner.

<Process for Restricting Total Toner Amount (Step S303)>

With reference to FIG. 4, the following describes a detailed flow of the process of step S303 in FIG. 3.

The flow of the process is executed on a pixel-by-pixel basis while referring to all of the colors C, M, Y and K of an image that has been adjusted in density. In step S402, a sum SUM1 of input CMYK (C1, M1, Y1 and K1) 401 is calculated. Here, CMYK (C1, M1, Y1 and K1) 401 denotes single-pixel data of a CMYK image generated in the earlier process of step S302. Next, in step S403, LIMIT (restriction value) 404 is read and compared with SUM 1. LIMIT (restriction value) 404 is a restriction value of an amount of toner that can be fixed, and is a predetermined value defined by a ratio to the largest value of a toner mounting amount for a single color, e.g., “240%”, provided that the largest value of each color (=255) is 100%. In the present example, the restriction value LIMIT is indicated under the assumption that 100% is converted into the largest value 255 of each color (as an example), for comparison and calculation purposes. For example, an upper limit value of the toner mounting amount is converted into a total density value, and therefore 240% is indicated as 612. This value is also stored in the storage unit 103. Next, in step S403, if SUM1 is equal to or smaller than LIMIT (restriction value) 404, CMYK (C1, M1, Y1 and K1) 401 is output as CMYK (C3, M3, Y3 and K3) 414 in step S413. Here, CMYK (C3, M3, Y3 and K3) 414 is single-pixel data of an output CMYK image in the present process for controlling a total toner amount.

If SUM1 is larger than LIMIT (restriction value) 404 in step S403, a UCR value is calculated using an expression shown in step S405. Here, the UCR value influences a value of reduction in toner of C, M and Y, and a value of increase in toner of K. In step S303 for controlling a total toner amount, in order to minimize a value of reduction in a toner amount, the half of an amount exceeding the restriction value ((SUM1−LIMIT)/2) or the smallest value among C1, M1 and Y1 is used as the UCR value. Next, in step S406, the image processing unit 102 calculates K2 among C2, M2, Y2 and K2, which are values after the first total toner amount restriction. Basically, a value obtained by adding the UCR value to K1 is used; however, as a value exceeding 100% (=255) cannot be set to K2 alone, a value of 100%, i.e., 255 is set to K2 if its value exceeds 100%. In step S406 of FIG. 4, the value of K2 is expressed in percentage, which indicates the largest density value because the density is not always 8 bits. Next, in step S407, the image processing unit 102 calculates values of C2, M2 and Y2 by reducing values of C1, M1 and Y1. It is assumed here that a difference between the value of K2 calculated in step S406 and the value of K1 is used as a subtrahend. Through the above-described process flow, CMYK (C2, M2, Y2 and K2) 408 representing a reduced total toner amount is calculated.

Next, in step S409, the image processing unit 102 calculates SUM2 by summing C2, M2, Y2 and K2. Next, in step S410, the image processing unit 102 reads LIMIT (restriction value) 404 and compares the same with SUM2. Here, if SUM2 is equal to or smaller than LIMIT (restriction value) 404, the image processing unit 102 outputs CMYK (C2, M2, Y2 and K2) 408 as CMYK (C3, M3, Y3 and K3) 414 in step S412. If SUM2 is larger than LIMIT (restriction value) 404, in step S411, the image processing unit 102 sets the value of K2 as-is as K3, and calculates a coefficient by dividing a value obtained by subtracting K2 from LIMIT (restriction value) 404 by a sum of C2, M2 and Y2. That is to say, this coefficient indicates a compression ratio for keeping a current sum of color components other than black, C2+M2+Y2, to or below a value obtained by removing the black component K2 from the restriction value LIMIT. Then, C3, M3 and Y3 representing reduced toner amounts are calculated by multiplying C2, M2 and Y2 by the calculated coefficient, and CMYK (C3, M3, Y3 and K3) 414 is output. This output also represents 8-bit data for a single pixel. It should be noted that the present process is illustrative, and the process for restricting a total toner amount is not limited in this way.

Through the procedures of FIGS. 3 and 4 described above, a total toner amount is restricted, and output data to which gamma correction and binarization processes have been applied is obtained.

However, there are cases in which an output image has different densities depending on a used recording medium, such as a recording sheet. This is attributed to the surface properties of the recording medium; provided that printing is conducted under the same condition, output image densities differ between a case in which a recording medium with rough surface properties is used and a case in which a recording medium with smooth surface properties is used. Specifically, in the case of a recording medium with rough surface properties, toner looks light because it enters gaps between fibers of the recording medium. As a result, not only does an image look low in density, but also a thin line that has been drawn may look discontinuous; that is to say, the output image is degraded. In order to absorb this change, calibration is performed for the following two items in accordance with a recording medium: a process condition described with reference to FIG. 2, and a restriction value used in the process for controlling a toner amount described with reference to step S303.

<Calibration Procedure>

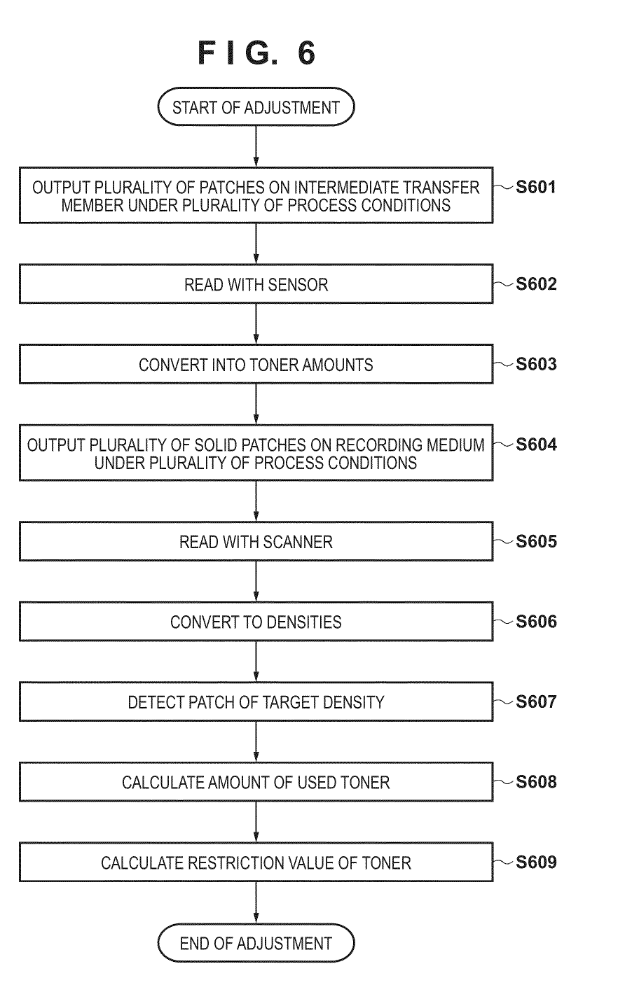

The flow of these calibrations will now be described with reference to FIG. 6. This calibration processing is executed in response to an instruction from the user before printing is conducted so as to obtain an adjustment value optimized for a recording medium to be used, and printing is conducted thereafter using the obtained adjustment value.

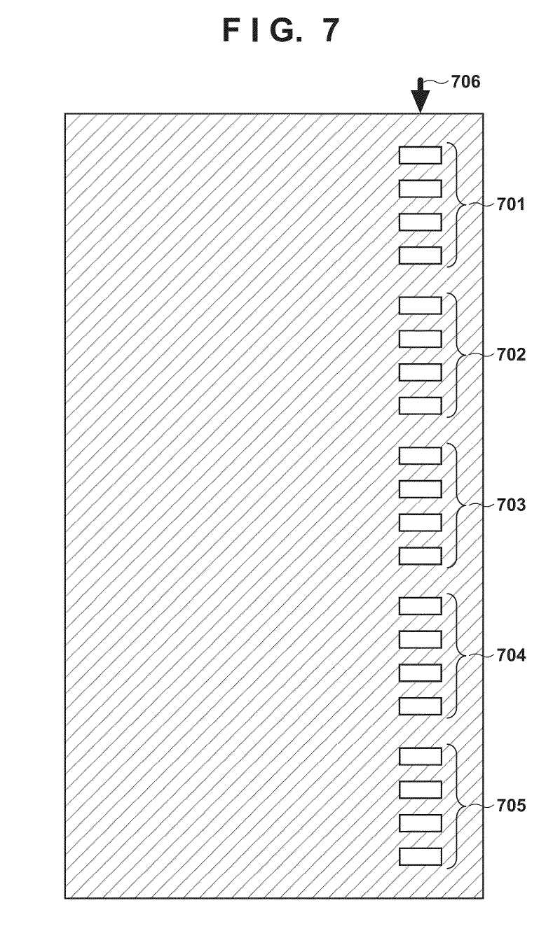

In step S601, the image processing unit 102 generates CMYK patches under a plurality of process conditions, and transfers toner images to the intermediate transfer member 206. It is assumed herein that patches denote one hundred percent solid patches to which halftone processing, such as dithering, has not been applied, unless particularly stated otherwise. As stated earlier, a process condition includes parameters such as the light amounts of laser beams and the exposure potentials of the photosensitive members; different patch densities are output by combining a plurality of such process conditions, that is to say, by changing a process condition. FIG. 7 depicts an image of patches on the intermediate transfer member. In this figure, each of CMYK patches is transferred under five types of process conditions in concert with a position 706 at which the photosensor 219 is arranged. Patches 701 to 705 formed under five types of process conditions each include patches of CMYK color components, and the process conditions vary in such a manner that these patches gradually increase in density in this order (that is to say, toward a lower side in the figure). Measured values of the patches can be obtained by the patches crossing the sensor as this intermediate transfer member rotates (as the patches proceed in an upward direction in the figure).

In step S602, the photosensor 219 converts toner images of the patches on the intermediate transfer member 206 into an electrical signal using the LED 217 and the photodiode 218, and processes the electrical signal through A/D conversion. Positions of the patches are identified by detecting changes in this digital value (hereinafter referred to as a sensor value). Specifically, at first, a read value of the intermediate transfer member itself is obtained at a read start position. Thereafter, a presence of a patch is found in a position showing a steep change in the value; starting with this patch, four patch images, i.e., C, M, Y and K patch images formed under the same process condition are found in sequence at an equal interval of time. This time can be obtained from a rotation speed of the intermediate transfer member. Thereafter, upon the elapse of a certain time period, C, M, Y and K toner images transferred under the next process condition are similarly found in sequence; this is repeated five times in the case of patches transferred as shown in FIG. 7. In this way, sensor values of patches on the intermediate transfer member are obtained.

In step S603, the CPU 104 converts the sensor values of the patches under the plurality of process conditions, which were obtained in step S602, into toner amounts. Values thereof differ depending on the sensor characteristics, the density of the intermediate transfer member itself, and a patch color (one of C, M, Y and K). Therefore, a one-dimensional lookup table showing a relationship between a sensor value and a toner amount is prestored in the storage unit 103 on a color-by-color basis, and a sensor value is converted into a toner amount accordingly. At this time, a unit of a toner amount is a toner mass per unit area, specifically, mg/cm². The present process makes it possible to obtain the amounts of toner used on the intermediate transfer member under the respective process conditions. It is also possible to estimate the amounts of toner used under intermediate conditions from the amounts of toner used under five discrete process conditions obtained in the above-described manner. For example, association between a process condition and a toner mounting amount is as follows. If a light amount is increased by increasing the luminance of a laser beam, a potential of an exposed portion of a surface of a photosensitive member decreases, and toner easily attaches. In contrast, if a potential for charging the surface of the photosensitive member is increased, a post-exposure residual charge increases, and toner becomes difficult to attach. Therefore, for example, in a case where a light amount of a laser beam and a potentials of a photosensitive member are used as parameters, if each of the parameters is set to change in 5 stages, 25 process conditions are realized by combining the parameters. Among these process conditions, for example, five process conditions are selected and used in step S601 at an interval of four stages in ascending order of toner density, patches formed under these process conditions are measured in step S602, and the measured values are converted into toner amounts in step S603. With regard to process conditions used in step S601, it is sufficient to preset several combinations of parameters theoretically or experimentally. It goes without saying that the number of combinations of parameters is not limited to five as shown in FIG. 7, and patches may be formed under a larger number of process conditions.

In step S604, the image processing unit 102 generates CMYK patches under a plurality of process conditions and prints these patches on a target recording medium, such as a recording sheet. The target recording medium (also referred to as a target print medium) is a type of a medium that is intended to be used in printing among a plurality of types of mediums that are usable in printing. Although an image of these patches is not shown, similarly to the aforementioned patches on the intermediate transfer member, each of C, M, Y and K patches is printed under five types of process conditions so that a targeted density of a one hundred percent solid patch (hereinafter referred to as a target density) can be obtained. In step S604, first, a process condition that yields the target density on a recording medium which has the smoothest surface properties and thus realizes the density with a small amount of toner is calculated from the amounts of used toner obtained in the earlier step S603. The medium with the smoothest surface properties is a medium on which the smallest amount of toner is used with respect to the density. Here, a toner amount for reproducing the target density on the recording medium with the smoothest surface properties is determined and stored in advance in step S603. In view of this, a toner amount that most resembles this stored toner amount is identified from among the toner amounts obtained in step S603, and a process condition corresponding to the identified toner amount is determined as a first reference process condition. On the basis of this process condition, in step S604, a plurality of process conditions are used in which the density, that is to say, the amount of used toner is increased in several more stages, e.g., five more stages. Starting from this first reference process condition, a plurality of process conditions, e.g., five process conditions are selected, in order, so as to gradually increase an amount of used toner. As these plurality of process conditions, first of all, the first reference process condition is selected as a process condition corresponding to the smallest amount of used toner. Then, as a process condition corresponding to the largest amount of used toner in the above-described range of patch densities, a process condition corresponding to an amount of toner used to reproduce the target density on a recording medium of the roughest surface properties is selected based on the toner amounts calculated in step S603. This selected process condition is used as a second reference process condition. It should be noted that, as the second reference process condition, a process condition that uses a toner amount equal to or larger than the amount of toner used to reproduce the target density on the recording medium with the roughest surface properties is selected from among the process conditions under which the patches were formed in step S601. It is assumed that the toner amount for reproducing the target density on the recording medium with the roughest surface properties has been measured and stored in advance. Then, process conditions for forming patches of different stages throughout which an amount of used toner gradually changes are determined between the first reference process condition and the second reference process condition. As the first and second reference process conditions have already been determined, it is sufficient to determine process conditions corresponding to stages therebetween. Then, in step S604, patches are formed on the target print medium under the predetermined number of process conditions that have been determined.

There is a possibility that the stages of the amounts of toner used to form the patches in step S604 are set more elaborately than the stages of the amounts of toner used to form the patches in step S601. In view of this, process conditions corresponding to the amounts of used toner in such more elaborate stages are determined in advance regardless of formation of the patches in step S601. For example, in a case where the luminance of a laser beam and a potential for charging a photosensitive member are used as process conditions, each of the process conditions is divided into 5 stages, and 25 process conditions are determined by combining them. Also, the order of the amounts of toner used to form patches under these process conditions is determined in advance. It is assumed here that none of the combinations uses the same amount of toner. In step S601, for example, among these 25 process conditions, patches are formed under process conditions at an interval of 5 stages, starting from a process condition in which the target density is formed using the smallest amount of toner. On the other hand, in step S604, among the 25 processes conditions, patches are formed under process conditions between the determined first reference process condition and second reference process condition. Among the amounts of used toner corresponding to the process conditions under which the plurality of patches are formed in step S604, the smallest and largest amounts of used toner are already known as they were obtained in the earlier step S603. In this way, the process conditions under which the patches are formed in step S604 include the process condition that yields the target density on a recording medium which has the smooth surface properties and hence requires a small amount of toner to yield the density, and the process condition that yields the target density also on a recording medium which has the rough surface properties and hence requires a large amount of toner to yield the density. Therefore, one of the patches formed in S604 reproduces the target density (or approximation thereof) on the target print medium.

In step S605, the recording medium that was printed out in the earlier step S604 is read using a scanner of the image reading unit 101 and converted into RGB image data. As the positions of the patches on the recording medium and the process conditions corresponding to the patches are already known, there is no need to perform special calculation to find the positions of the patches in the image data and the process conditions corresponding to the patches, and RGB values of patches of respective colors under respective conditions can be obtained.

In step S606, the CPU 104 converts the RGB values of the patches obtained in the earlier step S605 into densities. At this time, high and low patch densities can be elaborately detected by using RGB values of complementary colors for the patch colors, that is to say, red signals for cyan patches, green signals for magenta patches, and blue signals for yellow patches. It is assumed that green is used for black patches. Similarly to the aforementioned sensor values, this conversion does not necessarily show a linear relationship due to the reader characteristics; therefore, a corresponding lookup table is prestored in the storage unit 103, and the RGB values are converted into the densities of respective colors accordingly.

In step S607, the CPU 104 detects a patch closest to the target density from among the densities of respective colors obtained in the earlier step S606. The present detection process enables detection of a patch of a density that depends on a recording medium.

In step S608, an amount of toner that is necessary to yield the target density on a recording medium to be used is calculated. As the process condition of the patch that was detected in the earlier step S607 and yielded the target density is already known, an amount of toner used under that process condition was calculated in step S603 or can be estimated from the values calculated in step S603. For example, among the patches formed in step S604, the patch of the highest density and the patch of the lowest density were formed under the process conditions used in step S601, and therefore toner amounts thereof were calculated in step S603. With regard to patches of intermediate densities therebetween, their densities fall between the highest density and the lowest density formed in step S604; therefore, the amounts of toner used therefor can be estimated assuming that density and a toner amount are in a linear relationship in terms of, for example, minute density differences. Alternatively, if patches are formed in step S601 under all process conditions that could possibly be used in step S604 and the amounts of toner used therefor are calculated in step S603, the amount of used toner and the process condition corresponding to the target density can be identified in step S608 from among the amounts of used toner calculated in step S603. Up to the present process, a process condition for yielding the target density on the target recording medium and a corresponding amount of used toner M are established, and values thereof are retained in the storage unit 103.

Finally, in step S609, a restriction value for restricting toner on the recording medium to a total amount of toner that can be fixed by the fixing apparatus 215 under the process condition established in the earlier process (step S608) is obtained. This serves as the LIMIT value used in the process of step S303 for restricting a total toner amount in the above-described flow. In general, an upper limit of an amount of toner that can be fixed by a fixing apparatus per unit area is uniquely determined by the melting point of toner and by the heat quantity, pressure, and conveyance speed of the fixing apparatus, and a toner amount that exceeds the upper limit has a risk of causing poor fixing. That is to say, an upper limit N of an amount of toner that can be fixed is determined by a printer engine, and is given in accordance with specifications of the printer engine. Provided that an amount of toner that can be fixed is N mg/cm² and an amount of toner used under the aforementioned process condition is M mg/cm², a restriction value of (M*100)/N % is obtained. This value is retained in the storage unit 103 and used in the flow of step S303 at the time of image output.

The above-described procedure makes it possible to determine the process conditions and an upper limit value of a total toner amount suited for a medium used in printing (a target medium).

### Specific Example

Below, a description will be given again using specific numbers as an example. In step S601, solid patches are output under five process conditions A, B, C, D and E. It is assumed that an amount of used toner increases from A to E. It is also assumed that, subsequently, sensor values of 50, 40, 30, 20 and 10 are obtained from the respective process conditions in step S602, and these values are respectively converted into toner amounts of 0.2 mg/cm², 0.3 mg/cm², 0.4 mg/cm², 0.5 mg/cm² and 0.6 mg/cm² in step S603. Provided that a target density of 1.5 is yielded by 0.4 mg/cm² in the case of a recording medium with good surface properties, patches are output onto the recording medium under process conditions C, C1, C2, C3 and D in step S604. These conditions are obtained by segmentalizing the conditions between C and D, and it can be judged that the amount of used toner is in a range of 0.4 mg/cm² to 0.5 mg/cm². RGB values of 50, 40, 30, 20 and 10 are obtained by reading the output with the scanner in step S605, and densities of 1.3, 1.4, 1.5, 1.6 and 1.7 can be obtained by converting these RGB values in step S606. As a result, it can be judged in step S608 that the process condition C2 is necessary to achieve the target density of 1.5, and a value of a corresponding toner amount is 0.45 mg/cm². Finally, in step S609, provided that an amount of toner that can be fixed is 1.00 mg/cm², the following can be calculated as a ratio to this amount: 1.00*100/0.45=222%. In the above-described sequence, the following are regarded as constants that have been determined in advance and stored in the storage unit: on a recording medium with smooth surface properties, a target density of 1.5 is yielded by a toner amount of 0.4 mg/cm², and a toner amount of 1.00 mg/cm² is a fixing limit.

The above-described flow makes it possible to obtain a process condition for yielding a target density using a target print medium and a corresponding restriction value of a total toner amount, and to output target densities of respective colors by conducting printing under that condition regardless of the surface properties of a recording medium.

As described above, in the present embodiment, a density range is divided into a plurality of stages from a print medium that uses the smallest toner amount to a print medium that uses the largest toner amount to form patch images of a predetermined target density, and patch images are formed on a target print medium under process conditions corresponding to the respective stages. Densities of the formed patch images are measured, a patch closest to the target density is identified, and the corresponding process condition is determined as a process condition used in image formation. Also, an amount of toner used to form the patch images under that process condition is determined as the largest amount of toner consumed for a single color component under that process condition. An upper limit of a permitted toner mounting amount can be recognized as a density value by associating this amount of consumed toner with the largest density value for a single color component and by converting the largest toner mounting amount with which fixing can be performed, which is determined by a print engine, into a density value; therefore, in image formation, a toner mounting amount can be adjusted for each type of print medium before executing an image forming process.

### Second Embodiment

The above first embodiment has described calibration for the following two parameters in accordance with a recording medium: a process condition, and a restriction value used in the process for controlling a toner amount. While this calibration optimizes the density at which solid patches are formed for a recording medium, there is no assurance that a target density be yielded for halftone, which requires a dithering process.

In light of this, the present embodiment describes calibration for adjusting three parameters including a γ correction table in addition to a process condition and a restriction value used in the process for controlling a toner amount. With the present embodiment, not only the highest density but also a halftone density can be optimized for a recording medium.

It should be noted that a description of configurations of an image forming apparatus that are similar to those of the first embodiment, as well as a description of overlapping flows, will be omitted, and a description will be given of a calibration flow including a γ correction table, which is a characteristic point.

<Another Calibration Procedure>

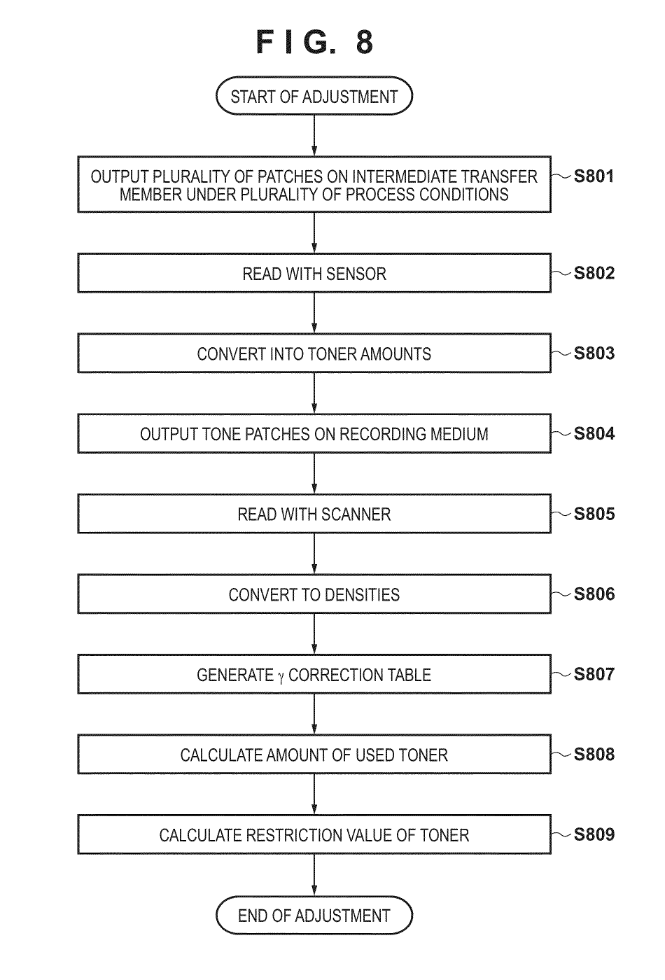

The flow of such calibration will now be described with reference to FIG. 8. This calibration processing is executed in response to an instruction from the user before printing is conducted so as to obtain an adjustment value optimized for a recording medium to be used, and printing is conducted thereafter using the obtained adjustment value. It should be noted that the flow executed at the time of printing is similar to the one described in the above first embodiment with reference to FIG. 3, and a description thereof will be omitted.

The flow from steps S801 to S803 is similar to processes of steps S601 to S603, and therefore a detailed description thereof will be omitted; up to these processes, the amounts of toner used on the intermediate transfer member under the respective process conditions can be obtained. From these plurality of process conditions and the amounts of toner used thereunder, a process condition that yields a target density on a recording medium of the roughest surface properties (requiring a large amount of toner to yield the density) under expected circumstances is determined, and a γ correction table that outputs the optimal tone properties and density under the determined condition is calculated. By measuring and storing in advance an amount of toner used to reproduce the target density on the recording medium of the roughest surface properties, a process condition corresponding to this amount of used toner can be determined from among the toner amounts calculated in step S803. It should be noted that, in a case where a gamma correction table to be used is determined here, it is preferable that a gamma correction table generated in step S807 be merged with the determined gamma correction table.

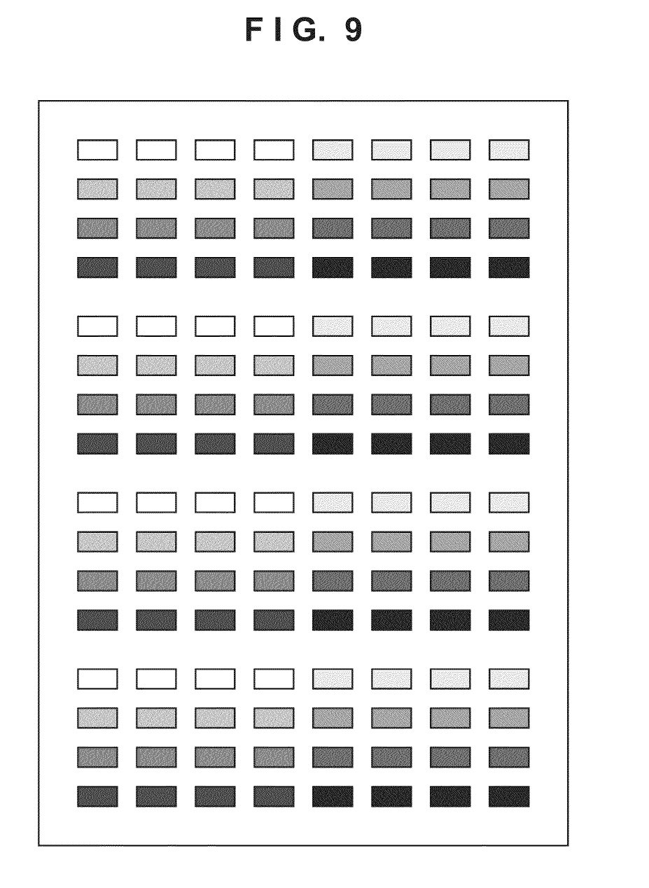

In step S804, the image processing unit 102 generates CMYK patches of a plurality of tones under the process condition determined in step S803, and prints these patches on a target recording medium, such as a recording sheet. FIG. 9 shows image data thereof. In this figure, a 32-tone patch of a single color is arranged repetitively for each of the colors C, M, Y and K. The values of the patches are obtained by equally dividing the values from 0 to 255, and therefore the patches with values of 7, 15, . . . , 247 and 255 are laid out at an interval of 8. The image processing unit 102 binarizes this data by applying thereto the dithering process of step S305 in the image output flow described with reference to FIG. 3, and outputs the binarized data from the image output unit 105.

In step S805, the recording medium that was printed out in the earlier step S804 is read using the scanner of the image reading unit 101 and converted into RGB image data. As the positions of the patches on the recording medium are already known, correspondence between the patches and the input image data as well as the process conditions can be identified from the positions of the patches, and therefore RGB values of the patches of respective colors in respective tones can be obtained.

In step S806, the CPU 104 converts the RGB values of the patches obtained in the earlier step S805 into densities. At this time, similarly to the above first embodiment, RGB values of complementary colors are used for the respective patch colors. Similarly to the above first embodiment, this conversion does not necessarily show a linear relationship due to the scanner characteristics; therefore, a corresponding lookup table is prestored in the storage unit 103, and the RGB values are converted into the densities of respective colors accordingly.

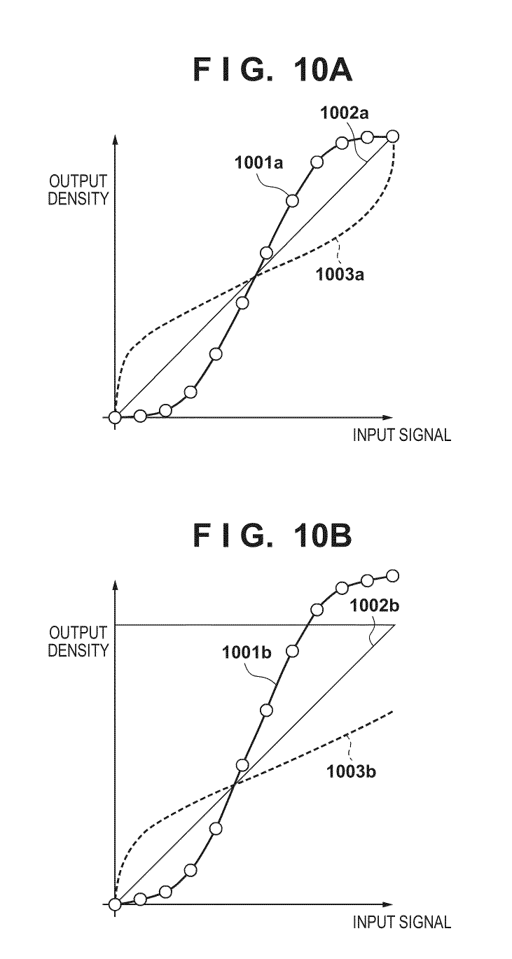

In step S807, the CPU 104 generates a γ correction table from the densities of respective colors obtained in the earlier step S806 so as to realize target tone characteristics. This will be described below with reference to FIGS. 10A and 10B. FIG. 10A shows a curve obtained by linearly connecting the discrete inputs of 64 tones so as to show a relationship with the output densities obtained in step S806. For simplicity, 12 discrete points are shown in the figure. A curve 1002a represents the target tone properties, and indicates that the exact target density is ultimately output with respect to the largest value of input. That is to say, the target density is yielded under the process condition determined in the earlier step S804, and therefore the used recording medium can be estimated to have rough surface properties from this result. As a result, the calculated γ correction table has characteristics represented by a characteristics curve 1003a. Similarly, in a case where a curve of FIG. 10B has been obtained, an output density obtained with respect to the largest value of input is significantly higher than the target density. That is to say, in this case, the process condition determined in the earlier step S804 yields an excessive density, and therefore the used recording medium can be estimated to have good surface properties from this result. A γ correction table to realize the target tone properties 1002b is represented by a curve 1003b. With this γ correction table, even if the largest value is input, the output value is clipped to a value below the largest value. The curve obtained in the above-described manner is retained as a lookup table in the storage unit 103, and used in the γ correction process of step S304 in the flow at the time of image output.

In step S808, an amount of toner that is necessary to yield the target tone properties on a recording medium to be used is calculated. This can be calculated using an output value corresponding to the largest input value in the γ correction table obtained earlier. Specifically, the γ correction process of step S304 is a process for performing 8-bit output with respect to 8-bit input, and the corresponding lookup table similarly shows 8-bit input and 8-bit output. That is to say, in the case of FIG. 10A, 255 is output with respect to input of the largest value 255. As an amount of toner used under this process condition is already known through the toner amount conversion process of step S803, provided that the value thereof is M, M itself serves as an amount of used toner. On the other hand, in the case of the curve of FIG. 10B, with respect to output of the largest value 255, a smaller value, e.g., 200 is input. That is to say, the target density is yielded by an amount smaller than the amount of used toner M. Given a linear relationship, an amount of used toner M′ corresponding to the target density can be obtained by the following calculation: M′=M×200/250. This M′ is retained in the storage unit 103 as the amount of used toner. Although the linear relationship has been given above, conversion using a lookup table can be implemented as well.

Finally, in step S809, a restriction value for restricting toner on the recording medium to a total amount of toner that can be fixed by the fixing apparatus 215 using the γ correction table established in the earlier process is obtained. Detailed calculation thereof is similar to the one in step S609 that has been described above in detail, and therefore a description thereof will be omitted.

The above-described flow makes it possible to obtain a process condition for yielding a target density using a target print medium, a corresponding restriction value of a total toner amount, and a γ correction table. By conducting printing with these parameters, not only can a target density be yielded for each color, but also the target halftone properties can be output, regardless of the surface properties of a recording medium.

### Third Embodiment

The above first and second embodiments have described configurations in which calibration enables reproduction of appropriate densities and tone properties on a printout regardless of a recording medium. However, these embodiments have not mentioned a case in which, as a result of calibration, a total amount of toner used to output the same image differs depending on a recording medium; in this case, appropriate control may not be performed for an amount of toner supplied to the supply mechanisms.

In view of this, the present embodiment describes a configuration in which a total amount of used toner is controlled differently on a per-recording medium basis. The present embodiment makes it possible to optimize not only the tone properties of an output image, but also a corresponding amount of supplied toner, for a recording medium.

It should be noted that a description of configurations of an image forming apparatus that are similar to those of the first embodiment, as well as overlapping flows, will be omitted, and a description will be given of a flow including the determination of a supply amount based on the result of calibration, which is a characteristic point.

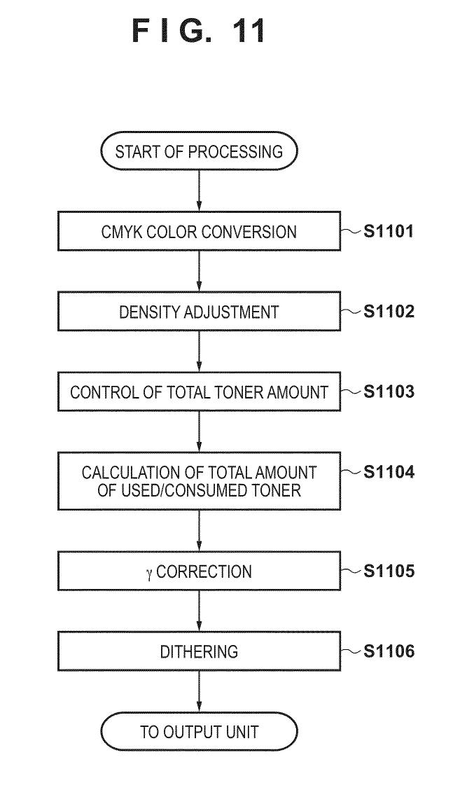

With reference to FIG. 11, the following describes the flow of printed image processing of the image processing unit 102 for obtaining a printed image. This flow is the same as the one described with reference to FIG. 3, with the addition of calculation of a total amount of used toner, and overlapping descriptions will be omitted.

Processes of steps S1101 to S1103 are similar to the processes of steps S301 to S303, and therefore a description thereof will be omitted.

In step S1104, the image processing unit 102 executes a process for calculating a total amount of toner used for an image. For the present process, CMYK 8-bit values are input, and an accumulated value is obtained by accumulating these values for all pixels constituting the image for each of C, M, Y and K. In the case of a solid-white image, the accumulated value is zero for every color; on the other hand, in the case of a monochrome image, the accumulated values for C, M and Y are zero, and only the accumulated value for K is non-zero. In a case where the number of all pixels is N, the largest accumulated value is 255×N.

The CPU 104 multiplies this accumulated value by a coefficient corresponding to a used recording medium. Specifically, an amount of used toner M that is necessary to output a target density on the recording medium is read from the storage unit 103 and used as a coefficient in a uniform unit system. As stated earlier, the unit of this toner amount M is mg/cm², and therefore the unit area 1 cm² is converted into the number of pixels. Provided that the number of pixels constituting 1 cm is K, the number of pixels constituting 1 cm² is K̂2 (̂ denotes a square). That is to say, a total amount of toner used for the entire image can be obtained in the unit mg by multiplying the accumulated value by M/(255×K̂2). The supply mechanisms 220Y, 220M, 220C and 220K are notified of this value.

Processes of steps S1105 and S1106 are similar to the processes of steps S304 and S305, and therefore a description thereof will be omitted.

The amount of used toner M, which was used in the earlier step S1104, can be obtained in the process for calculating the amount of used toner in steps S608 and S808 in the flows of FIGS. 6 and 8 according to the above-described working examples, and therefore a detailed description thereof will be omitted.

By adopting this configuration, a total amount of toner used at the time of image output can be obtained with high accuracy in accordance with a used recording medium, and the accuracy of toner supply can be improved.

While the present embodiment has used linear multiplication/division in conversion of a unit system, it is also possible to adopt a configuration that uses a lookup table in consideration of nonlinear properties.

Also, while the present embodiment has described a configuration in which a total amount of toner used at the time of image output is reflected in control of toner supply, it can also be reflected in, for example, detection of an amount of toner remaining in the apparatus and charge of a print fee corresponding to a total amount of used toner.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-273170, filed Dec. 27, 2013, which is hereby incorporated by reference herein in its entirety.

What is claimed is:

1. An image forming apparatus in which an upper limit value of an amount of recording agent per unit area used in image formation has been preset, the image forming apparatus comprising:
a calculation unit that forms a patch on an intermediate transfer member under a plurality of conditions that yield different densities, and calculates amounts of recording agent used for the patches;
a forming unit that, based on the calculated amounts of used recording agent, forms on a target print medium a plurality of patches using different amounts of recording agent under a plurality of different conditions;
a unit that measures densities of the plurality of patches formed on the target print medium, and identifies a patch of a target density; and
a unit that obtains the upper limit value based on an amount of used recording agent corresponding to the identified patch of the target density.

2. The image forming apparatus according to claim 1, wherein
the forming unit identifies, from the amounts of recording agent used for the patches calculated by the calculation unit, a condition corresponding to an amount of recording agent used to form the patch of the target density on a print medium that requires a smallest amount of used toner with respect to density among a plurality of types of print mediums used in image formation, uses the identified condition as a first reference, and forms the plurality of patches using a plurality of conditions in which an amount of used recording agent gradually increases as the plurality of different conditions.

3. The image forming apparatus according to claim 2, wherein
the forming unit identifies, from the amounts of recording agent used for the patches calculated by the calculation unit, a condition corresponding to an amount of recording agent used to form the patch of the target density on a print medium that requires a largest amount of used recording agent with respect to density among the plurality of types of print mediums used in image formation, uses the identified condition as a second reference, and forms the plurality of patches using a plurality of conditions in which an amount of used recording agent gradually increases from the first reference condition to the second reference condition as the plurality of different conditions.

4. The image forming apparatus according to claim 1, further comprising
a unit that stores, among the plurality of different conditions, a condition corresponding to the patch of the target density as a condition for image formation, wherein
image formation based on image data is performed under the stored condition.

5. The image forming apparatus according to claim 1, wherein
when image formation based on image data is performed, a per-pixel total density is restricted so as not to exceed the upper limit value.

6. The image forming apparatus according to claim 1, wherein
the forming unit forms the patches on a per-color component basis in a highest density.

7. The image forming apparatus according to claim 1, wherein
the forming unit forms the patches on a per-color component basis in a plurality of densities through application of a dithering process,
the image forming apparatus further comprises a unit that applies gamma correction to image data prior to the dithering process,
the forming unit further identifies, from the amounts of recording agent used for the patches calculated by the calculation unit, a condition corresponding to an amount of recording agent used to form the patch of the target density on a print medium that requires a largest amount of used recording agent with respect to density among a plurality of types of print mediums used in image formation, and
the image forming apparatus further comprises a unit that determines characteristics of the gamma correction by measuring the plurality of densities of the patches formed under the identified condition.

8. The image forming apparatus according to claim 1, further comprising
a unit that obtains a total amount of recording agent consumed to form a single image.

9. The image forming apparatus according to claim 1, wherein
the image forming apparatus forms an image in accordance with an electrophotographic method using toner as the recording agent.

10. An adjustment method for an image forming apparatus in which an upper limit value of an amount of recording agent per unit area used in image formation has been preset, the adjustment method comprising:
forming a patch on an intermediate transfer member under a plurality of conditions that yield different densities, and calculating amounts of recording agent used for the patches;
based on the calculated amounts of used recording agent, forming on a target print medium a plurality of patches using different amounts of recording agent under a plurality of different conditions;
measuring densities of the plurality of patches formed on the target print medium, and identifying a patch of a target density; and
obtaining the upper limit value based on an amount of used recording agent corresponding to the identified patch of the target density.
